(19) United States
(12) Patent Application Publication
(10) Pub. No.: US 2026/0335828 A1
(43) Pub. Date: Oct. 29, 2026

(54) MULTI-STAGE REVERSE OSMOSIS CIRCUIT AND PROCESS FOR BORON REMOVAL IN DIRECT LITHIUM EXTRACTION

(71) Applicant: ILiAD IP COMPANY, LLC, Carlsbad, CA (US)

(72) Inventor: Aaron Philip POON, Tustin, CA (US)

(73) Assignee: ILiAD IP COMPANY, LLC, Carlsbad, CA (US)

(21) Appl. No.: 19/642,718

(22) Filed: Apr. 9, 2026

Related U.S. Application Data
(60) Provisional application No. 63/794,043, filed on Apr. 24, 2025.

(51) Int. Cl. B01D 61/02; B01D 61/08; B01D 61/58

(52) U.S. Cl. CPC B01D 61/026; B01D 61/08; B01D 61/58; B01D 2257/00; B01D 2311/18; B01D 2311/2513; B01D 2317/025; B01D 2317/04; B01D 2317/06

(57) ABSTRACT

This disclosure relates to a process and circuit for removing boron from a lithium-containing eluate in a direct lithium extraction process. The process adjusts the lithium-containing eluate to a first pH condition to facilitate boron partitioning, then passes the lithium-containing eluate through a first-stage membrane separation unit to produce a boron-laden permeate stream and a lithium-containing eluate with reduced boron content. The boron-laden permeate stream is adjusted to a second pH condition to convert boric acid to borate ions, and then passed through a second-stage membrane separation unit to produce a boron-reduced permeate stream. The boron-reduced permeate stream is recycled, and the lithium-containing eluate with reduced boron content can be directed to a conversion process circuit.

### CROSS-REFERENCE TO RELATED APPLICATIONS

This application claims the benefit of United States Provisional Patent Application No. 63/794,043 filed Apr. 24, 2025, and incorporates the provisional application by reference in its entirety into this document as if fully set out at this point.

### BACKGROUND OF THE INVENTION

### 1. Field of the Invention.

The present disclosure relates to lithium extraction technologies and, more particularly, to direct lithium extraction process circuits and multi-stage membrane separation process circuits for boron removal from a lithium-containing eluate.

### 2.Background of the Invention:

In modern processing systems, lithium is typically extracted from complex feed solutions that also contain various impurities. The extraction processes have evolved over the years to incorporate multiple separation techniques designed to enhance product quality while maintaining robust operational performance. As demand for battery-grade lithium compounds continues to grow, the industry has placed considerable emphasis on developing processing strategies to effectively address the challenges posed by impurity-laden streams. In this context, maintaining control over feed quality and integrating advanced separation methods have become important aspects in the evolution of lithium extraction technologies.

A goal in the evolution of lithium extraction technologies is to improve product purity, process efficiency, and cost-effectiveness. Technological advancements are increasingly focused on integrating separation and purification steps that can be seamlessly incorporated with conventional extraction circuits. The objective is to streamline operations while reducing chemical use and energy consumption and minimizing the overall process’s environmental footprint. By enhancing the operational dynamics, resilient systems can adapt to fluctuating feed characteristics and variable operating conditions.

Within these processing systems, traditional methods for impurity management often face limitations when dealing with the complex chemistry in extraction feed streams. While functional, conventional solutions can be hampered by high operational costs, significant resource consumption, and the need for intensive chemical handling. These methods sometimes require multiple steps to achieve the level of purification necessary for downstream applications, thereby increasing process complexity and energy demand. The challenges of managing certain contaminants may lead to inefficiencies in the extraction workflow, with existing processes proving less than optimal in consistently delivering the required purity levels. As a result, there is a strong need for refined techniques that circumvent these limitations while achieving both high performance and operational economy.

In some extraction configurations, specific contaminants that persist throughout processing can yield particularly complex challenges. Certain impurities, due to their repetitive nature, can accumulate in the process stream and interfere with subsequent purification steps, which are important to the overall quality of the final lithium product. The recurring presence of these components necessitates additional treatment measures and more precise control over processing parameters, often resulting in heightened chemical use and increased system complexity. In particular, for alumina-based direct lithium extraction (DLE) systems, boron impurities pose a significant challenge. Boron impurities, if untreated, can cycle up in the DLE eluate and affect the production of battery-grade lithium carbonate. Traditional methods such as ion exchange (IX) and solvent extraction have high CAPEX and OPEX, alongside intensive chemical requirements, making them resource-intensive, costly, and inefficient.

Such challenges underscore the need to develop improved strategies to effectively remove or substantially reduce these targeted impurities, thereby facilitating more stable, economically viable extraction operations that deliver battery-grade lithium with the desired level of purity.

### SUMMARY OF THE INVENTION

This invention addresses boron carryover challenges in DLE systems utilizing alumina-based adsorbent media. The invention employs a multi-stage membrane separation process circuit, leveraging pH-dependent partitioning to achieve boron removal with up to 99 % efficiency. The invention can also incorporate upstream pretreatment process circuit(s) and/or downstream impurity removal process circuit(s) to improve impurity rejection and lithium extraction. The invention also includes advanced process controls and recycling of water and permeate streams back into the DLE system to ensure optimized operation and improve the system’s overall efficiency.

In general, in a first aspect, the disclosure relates to a process for removing boron from a lithium-containing eluate in a direct lithium extraction process. The process includes receiving a lithium-containing eluate containing boron impurities from a direct lithium extraction process, adjusting a pH of the lithium-containing eluate to a first pH condition to facilitate partitioning of boron, passing the lithium-containing eluate through a first-stage membrane separation unit to produce a boron-laden permeate stream and a lithium-containing eluate with reduced boron content, adjusting the pH of the boron-laden permeate stream to a second pH condition to convert boric acid into borate ions, passing the boron-laden permeate stream through a second-stage membrane separation unit to further reduce boron content and produce a boron-reduced permeate stream, and recycling the boron-reduced permeate stream.

In an embodiment, adjusting the pH of the lithium-containing eluate can comprise adjusting the pH of the lithium-containing eluate to the first pH condition of up to about 8, for example about 6 to about 7, to facilitate hydraulic partitioning of boron into the boron-laden permeate stream. In an embodiment, adjusting the pH of the lithium-containing eluate can comprise adjusting the pH of the lithium-containing eluate to the first pH condition using an acid comprising hydrochloric acid or sulfuric acid.

In an embodiment, the first-stage boron membrane separation unit can comprise an acid-resistant membrane comprising commercially available membranes, thin-film composite membranes, cellulose acetate membranes, seawater reverse osmosis membranes, high-pressure reverse osmosis membranes, osmotically assisted reverse osmosis membranes, counterflow reverse osmosis membranes, forward osmosis with reverse osmosis hybrid membranes, or a combination thereof. The first-stage membrane separation unit can be operated in a continuous, batch, semi-batch, cyclic, staged, cascaded, recirculating, counter-current, co-current, or hybrid configuration. In an embodiment, the acid-resistant membrane can comprise one or more membrane elements arranged in series or parallel.

In an embodiment, adjusting the pH of the boron-laden permeate stream can comprise adjusting the pH of the boron-laden permeate stream to a value between about 10 and about 14 to convert boric acid into borate ions. In an embodiment, adjusting the pH of the boron-laden permeate stream to the second pH condition can comprise the addition of an alkali comprising sodium hydroxide, potassium hydroxide, lithium hydroxide, or a combination or mixture thereof.

In an embodiment, the second-stage membrane separation unit can comprise an alkaline-resistant membrane comprising commercially available membranes, alkaline-resistant thin-film composite membranes, brackish water reverse osmosis membranes, ultra-low pressure reverse osmosis membranes, specialized high-pH reverse osmosis membranes, or a combination thereof. The second-stage membrane separation unit can be operated in a continuous, batch, semi-batch, cyclic, staged, cascaded, recirculating, counter-current, co-current, or hybrid configuration. In an embodiment, the alkaline-resistant membrane can comprise one or more membrane elements arranged in series or parallel.

In an embodiment, the process can further comprise, prior to the direct lithium extraction process, directing a lithium-containing feed solution containing boron impurities to a pretreatment process circuit configured to remove one or more impurities. In an embodiment, the direct lithium extraction process can be configured to operate in a fixed bed, simulated moving bed, continuous counter-current ion exchange (CCIX), or continuous counter-continuous counter-current adsorption/desorption (CCAD) configuration.

In an embodiment, the process can further comprise directing the lithium-containing eluate containing boron impurities to an impurity removal process circuit configured for removing hardness ions comprising calcium and magnesium ions to produce the lithium-containing eluate with reduced boron content. In an embodiment, the impurity removal process circuit can comprise softening the lithium-containing eluate containing boron impurities, filtering the lithium-containing eluate containing boron impurities, and/or polishing the lithium-containing eluate containing boron impurities.

In an embodiment, the process can further comprise directing the lithium-containing eluate with reduced boron content to a conversion process circuit to produce one or more borate salt products. In an embodiment, the process can further comprise monitoring the pH of the lithium-containing eluate and/or the boron-laden permeate stream using sensors and adjusting the addition of the acid or alkali based on the monitored pH values.

In general, in a second aspect, the disclosure relates to a direct lithium extraction system. The direct lithium extraction system includes a direct lithium extraction process circuit configured to produce a lithium-containing eluate from a lithium-containing feed solution and a multi-stage membrane separation circuit configured for boron removal from the lithium-containing eluate to produce a boron-reduced permeate stream and a boron-laden concentrate stream.

In an embodiment, the multi-stage membrane separation process circuit can further comprise a first-stage boron reverse osmosis unit configured to partition boron into a boron-laden permeate stream and produce a lithium-containing eluate with reduced boron content, a second-stage boron reverse osmosis unit configured to further reduce boron content and produce a boron-reduced permeate stream, and a recycle conduit fluidly connecting the boron-reduced permeate stream from the second reverse osmosis unit to the direct lithium extraction process circuit.

In an embodiment, the first-stage boron reverse osmosis unit can include an acid-resistant membrane comprising a commercially available reverse osmosis membrane, a thin-film composite reverse osmosis membrane, a cellulose acetate reverse osmosis membrane, a seawater reverse osmosis membrane, a high-pressure reverse osmosis membrane, an osmotically assisted reverse osmosis membrane, a counterflow reverse osmosis membrane, a forward osmosis with reverse osmosis hybrid membrane, or a combination thereof. The acid-resistant membrane can comprise one or more membrane elements arranged in series or parallel. The first-stage reverse osmosis unit can comprise a continuous, batch, semi-batch, cyclic, staged, cascaded, recirculating, counter-current, co-current, or hybrid configuration.

In an embodiment, the second-stage boron reverse osmosis unit can include an alkaline-resistant membrane comprising a commercially available membrane, an alkaline-resistant thin-film composite membrane, a brackish water reverse osmosis membrane, an ultra-low pressure reverse osmosis membrane, a specialized high-pH reverse osmosis membrane, or a combination thereof. The alkaline-resistant membrane can comprise one or more membrane elements arranged in series or parallel. The second-stage boron reverse osmosis unit can be operated in continuous, batch, semi-batch, cyclic, staged, cascaded, recirculating, counter-current, co-current, or hybrid configurations.

In an embodiment, the direct lithium extraction system can further comprise a pretreatment process circuit upstream of the direct lithium extraction process circuit and configured to remove one or more impurities from the lithium-containing feed solution. In an embodiment, the direct lithium extraction process circuit can be a fixed bed, simulated moving bed, continuous counter-current ion exchange (CCIX), or continuous counter-continuous counter-current adsorption/desorption (CCAD) process circuit.

In an embodiment, the direct lithium extraction system can further comprise an impurity removal process circuit downstream of the direct lithium extraction process circuit and configured for removing hardness ions comprising calcium and magnesium ions to produce the lithium-containing eluate with reduced boron content. In an embodiment, the impurity removal process circuit can comprise a softening process circuit, a filtration process circuit, and/or a polishing process circuit.

In an embodiment, the direct lithium extraction system can further comprise a conversion process circuit downstream of the impurity removal process circuit and configured to produce one or more borate salt products.

### BRIEF DESCRIPTION OF THE DRAWINGS

The above and other objects and advantages of this invention may be more clearly seen when viewed in conjunction with the accompanying drawing wherein:

FIG. 1 is a process flow diagram of an example of a direct lithium extraction process and circuit having a multi-stage reverse osmosis for boron removal and permeate recycling in accordance with an illustrative embodiment of the invention disclosed herein.

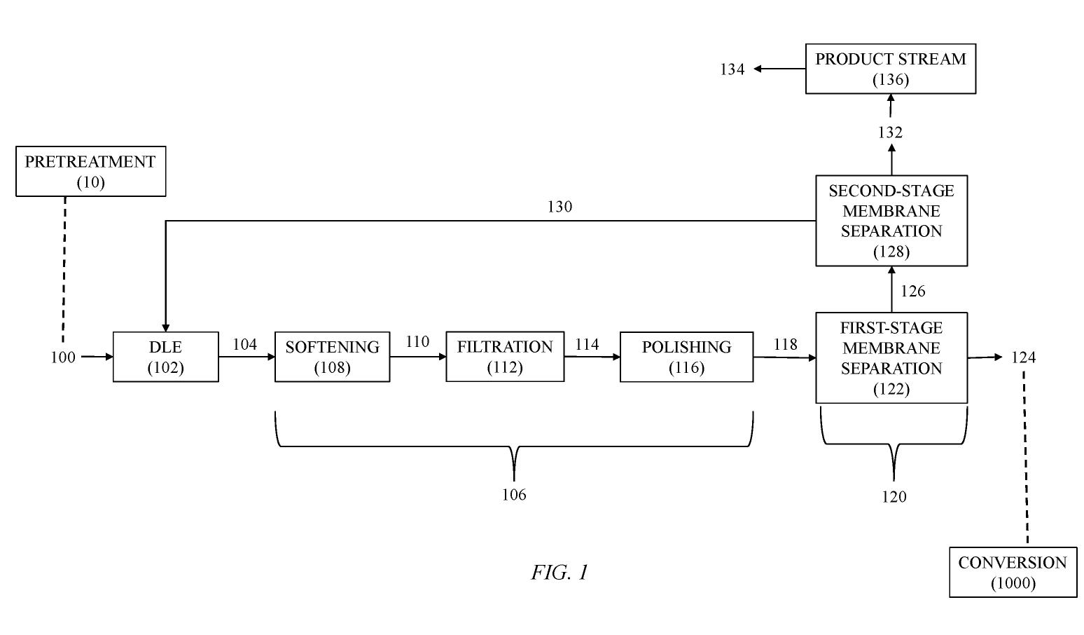

### DETAILED DESCRIPTION OF THE INVENTION

The detailed description provides illustrative embodiments of the disclosed subject matter, which generally pertains to processes and circuits for direct lithium extraction (DLE) and multi-stage membrane separation for boron removal from a lithium-containing eluate. The disclosed subject matter is particularly relevant to the field of lithium recovery technologies, including methods for enhancing the purity of lithium eluates. While specific examples, configurations, and operational parameters are described herein, these are intended solely to illustrate the principles of the disclosed subject matter and are not to be construed as limiting the scope of the described processes and circuits. The disclosed subject matter encompasses various modifications, substitutions, and rearrangements that would be apparent to those skilled in the art, and such variations are considered within the scope of the claims.

In direct lithium extraction process circuits, a lithium-containing eluate may carry boron through downstream purification and conversion operations, making it difficult to achieve consistent production of lithium products at the desired purity. Boron may also accumulate in a recycle-based process circuit, thereby increasing impurity management burdens and reducing overall process efficiency. In addition, impurity-removal approaches that rely on intensive chemical handling or add to separation complexity can increase operating costs, resource consumption, and process burden, particularly when hardness ions and other dissolved species may interfere with downstream membrane performance.

The invention is directed to a process and circuit for boron removal from a DLE eluate using a multi-stage membrane separation process circuit that capitalizes on selective partitioning behaviors of boron under varying pH conditions. In some embodiments, the multi-stage membrane separation process circuit can include a first-stage membrane separation or reverse osmosis unit configured to facilitate partitioning of boron into a boron-laden permeate stream and a second-stage membrane separation or reverse osmosis unit configured to further reduce boron content and produce a boron-reduced permeate stream that can be recycled, such as through a recycle conduit fluidly connecting the boron-reduced permeate stream to the direct lithium extraction process circuit. The first-stage reverse osmosis unit operates under low-pH/acidic conditions to hydraulically partition boron into the boron-laden permeate stream, which is directed to the downstream, second-stage reverse osmosis unit that operates under high-pH/alkaline conditions, converting boric acid (H₃BO₃) to borate (BO₃ ³⁻) to enhance membrane rejection. The multi-stage boron membrane separation process circuit removes up to about 99 % of the boron before recycling the boron-reduced permeate stream from the second-stage RO unit to the DLE process circuit. This multi-stage approach not only minimizes boron buildup in the DLE process circuit but also avoids the inefficiencies of ion exchange or solvent extraction for boron impurity removal.

As used herein, membrane separation refers to any separation, concentration, purification, fractionation, or conditioning process in which a semi-permeable membrane is employed to selectively permit passage of one or more components of a fluid stream while restricting passage of one or more other components, based on size, charge, speciation, valence, hydration energy, chemical affinity, osmotic pressure, electrical potential, thermal gradient, concentration gradient, or combinations thereof. Membrane separation processes may be operated under pressure-driven, osmotic-driven, electrically driven, thermally driven, diffusion-driven, or hybrid driving forces. Membrane separation includes using any suitable membrane chemistry, module configuration, or operating mode, including single-pass, multi-pass, multi-stage, cascaded, staged, recirculating, cyclic, counterflow, osmotic-assisted, or hybrid configurations.

As noted above, membrane separation processes may be operated under pressure-driven forces. For example, microfiltration (MF) includes pressure‑driven membrane separation processes employing porous membranes configured to remove suspended solids, particulates, and turbidity from lithium‑bearing solutions or intermediate process streams, including pretreatment of brines, eluates, or recycle streams to protect downstream membrane separation or DLE unit operations. Ultrafiltration (UF) includes pressure‑driven membrane separation processes employing semi‑permeable membranes configured to remove colloids, macromolecules, fine particulates, or biological matter from lithium‑bearing solutions or process waters, including as a pretreatment or polishing step upstream of nanofiltration, reverse osmosis, ion exchange, or other downstream membrane separation processing units. Further, nanofiltration (NF) includes pressure-driven membrane separation processes employing semi-permeable membranes having a separation range intermediate between ultrafiltration and reverse osmosis, and configured to selectively separate dissolved species based on molecular size, ionic charge, valence, hydration radius, surface charge effects, or combinations thereof. In direct lithium extraction, nanofiltration uses membrane separation to reduce or manage divalent and multivalent ions, such as calcium and magnesium, relative to monovalent ions. It may also be used as an alternative or supplement to chemical softening and/or ion exchange for hardness and scaling control.

Membrane separation processes may also be operated under osmotic-driven forces, such as reverse osmosis (RO), which includes pressure-driven membrane separation processes in which hydraulic pressure is applied to drive solvent across a semi-permeable membrane against an osmotic pressure gradient, thereby affecting the separation of dissolved salts, ionic species, and low-molecular-weight solutes. In DLE systems, reverse osmosis includes processes configured for impurity control, dewatering, concentration, and water recovery from lithium-bearing eluates, including lithium chloride and/or sulfate solutions.

Reverse osmosis includes, without limitation, conventional reverse osmosis, thin-film composite (TFC) reverse osmosis, cellulose acetate reverse osmosis, brackish-water reverse osmosis (BWRO), seawater reverse osmosis (SWRO), high-pressure reverse osmosis, ultra-low pressure reverse osmosis (ULP), acid-resistant reverse osmosis, alkaline-resistant reverse osmosis, high-pH reverse osmosis, counter-flow reverse osmosis (CFRO), osmotically assisted reverse osmosis (OARO), forward-osmosis-assisted reverse osmosis, hybrid FO-RO, or combinations of configurations thereof, in closed-circuit, cyclic, batch, or semi-batch reverse osmosis configurations.

Membrane separation processes can also include forward osmosis (FO), in which solvent transport across a semi-permeable membrane is driven primarily by an osmotic pressure gradient rather than an externally applied hydraulic pressure. Forward osmosis may be employed alone or in combination with reverse osmosis, including forward-osmosis-assisted reverse osmosis and hybrid FO-RO configurations used for preconcentration, dilution, water recovery, or impurity management in lithium extraction flowsheets.

Membrane separation processes may be operated under electrically driven forces, such as electrodialysis (ED), in which an applied electric potential drives selective transport of ions across alternating cation‑exchange and anion‑exchange membranes. Electrodialysis includes electrodialysis reversal (EDR) systems and may be employed to adjust ionic ratios, reduce multivalent ion content, or manage impurity profiles in lithium‑bearing solutions. Bipolar membrane electrodialysis (BMED) can also be utilized, which incorporates bipolar membranes configured to split water into hydrogen and hydroxide ions under an applied electric field, enabling in‑situ generation of acids and bases for pH control, reagent regeneration, or acid/base management within lithium extraction flowsheets.

As used herein, partitioning boron refers to preferential distribution of boron species between permeate and concentrate (retentate) streams as a function of solution pH, boron speciation, membrane selectivity, and operating conditions, including partial, staged, multi-pass, or multi-unit partitioning across one or more membrane separation units.

Any filtration, membrane separation, MF, UF, NF, RO, FO, ED, BMED, or ion exchange process circuit described herein may be operated in continuous, batch, semi-batch, cyclic, staged, cascaded, recirculating, counter-current, co-current, or hybrid configurations, may comprise one or more membrane elements arranged in series or parallel, and may be integrated with chemical softening, polishing, ion exchange, adsorption, precipitation, evaporation, crystallization, electrochemical conversion, or solvent extraction steps within a direct lithium extraction flowsheet.

The disclosed system and process for boron removal in direct lithium extraction using multi-stage membrane separation or reverse osmosis can be integrated with a pretreatment process circuit (10), a DLE process circuit (102), and an impurity removal process circuit (106) for softening (108), filtering (112), and polishing (116) to enhance impurity management and improve the production of battery-grade lithium carbonate or lithium hydroxide in a conversion process circuit (1000).

A lithium-bearing solution (100) can be one or a blend of chloride, sulfate, or other lithium-bearing solutions, such as a natural brine, a synthetic brine, or a combination thereof, such as a continental brine, a geothermal brine, an oil field brine, a brine or leachate solutions from ore, hard rock, clay, or other lithium mining and beneficiation, solutions from battery recycling processes, mother liquors, pregnant leach or liquor solutions (PLS), or a combination thereof, from any lithium resource.

The lithium-bearing solution (100) can be passed directly to the DLE process circuit (102) with no or minimal pretreatment or may be subject to one or more preliminary treatment steps, including the removal of solids, sulfides, organic materials, and certain problem metals or metals of commerce (e.g., iron, manganese, zinc, silicon, etc.) in the pretreatment process circuit (10). For example, the pretreatment process circuit (10) may include clarification, filtration, oxidation or reduction, degassing, flotation, membrane separation-based pretreatment or preconcentration, or combinations thereof, selected to condition the lithium‑bearing solution (100) for stable operation of the downstream process circuits. If the feedstock contains low lithium concentrations, the lithium-bearing solution (100) can be preconcentrated before the DLE process circuit (102), such as by distillation, evaporation, membrane separation, reverse osmosis, or the like.

The DLE process circuit (102) selectively extracts lithium ions directly from lithium-bearing solutions (100) using advanced technologies like adsorption, ion exchange, membrane separation, electrochemical extraction, or solvent extraction. For example, the DLE process circuit (102) can utilize lithium-selective adsorbent media to selectively extract lithium ions from the lithium-bearing solution (100). The DLE process circuit (102) can operate in a fixed bed, simulated moving bed, continuous counter-current ion exchange (CCIX), or continuous counter-continuous counter-current adsorption/desorption (CCAD) configuration, in which fresh lithium-bearing solution (100) interacts with the adsorbent media to ensure efficient lithium extraction. During the desorption phase, an eluant is employed to release lithium ions from the media, producing a concentrated lithium eluate enriched with residual impurities, including boron, calcium, and magnesium. Similarly, other DLE process circuits, such as membrane separation, electrochemical extraction, or solvent extraction, produce aqueous lithium eluates, permeates, and other process streams with boron impurities.

Adsorption- and ion exchange-based DLE process circuits (102) can utilize a lithium-selective adsorbent to selectively extract lithium ions from the lithium-bearing solution (100). The lithium-selective adsorbent can be a lithium aluminum double hydroxide (LADH), such as lithium aluminum layered double hydroxide chloride (LiXAl₂(OH)₆Cl_{X}), Gibbsite-based (or Gibbsite’s common polymorphs, e.g., Bayerite, Boehmite, and Nordstrandite) lithium aluminum layered double hydroxide, lithium aluminum intercalate (LiAl₂(OH)₆Cl) crystals in macroporous, polymeric resin beads or other suitable adsorbent support. The lithium selective adsorbent can also be a lithium alumina intercalate prepared from hydrated alumina, a layered double hydroxide modified activated alumina, a layered double hydroxide imbibed ion exchange resin or copolymer or molecular sieve or zeolite, layered aluminate polymer blends, a lithium manganese oxide, a titanium oxide, an immobilized crown ether, a metal-organic framework, or a combination thereof.

The DLE process circuit (102) includes a plurality of adsorption beds or columns, each containing the alumina-based lithium-selective adsorbent. The adsorption beds are sequentially subjected to individual process zones within the DLE process circuit (102). Each process zone includes one or more adsorbent beds configured in parallel, in series, or in a combination of parallel and series, flowing in upflow or downflow modes. Fluid flow through the DLE process circuit (102) can be controlled by adjusting pumping flow rates and/or by predetermined indexing of a rotary or carousel, multiport valve system, adsorbent beds, or both, creating a process in which the adsorption beds continually cycle through the individual process zones. The lithium-bearing solution (100) flows countercurrently to the advancing adsorption beds, and lithium ions bind selectively to the adsorbent media. A controlled flow of an eluant (e.g., a lithium strip solution) is introduced countercurrently into the process zone, advancing to displace bound lithium from the adsorbent media, producing a DLE process circuit lithium-containing eluate (104). The eluant/lithium strip solution comprises a low-concentration lithium-containing eluant (as neutral salts, generally lithium chloride) in water, at a concentration of about 0 mg/kg to about 1000 mg/kg lithium, and at temperatures of about 5° C to about 100° C.

The DLE process circuit eluate (104) undergoes impurity removal in an impurity removal process circuit (106) configured to selectively remove impurities from the lithium-containing eluate (104) from the DLE process circuit (102). The impurity removal process circuit (106) can include a softening process circuit (108) to remove hardness ions such as calcium and magnesium that could precipitate and damage downstream RO membranes.

In certain embodiments, the softening process circuit (108) can include hardness removal by chemical softening, which may be implemented as a single‑stage operation, reflecting the bulk precipitation‑based nature of the softening process. In such embodiments, hardness ions such as calcium and magnesium are removed by controlled addition of softening reagents, such as lime (Ca(OH)₂) or soda ash (Na₂CO₃), to precipitate insoluble salts, followed by solid–liquid separation, without requiring multiple staged separation units. Single‑stage softening may be sufficient to reduce scaling potential to levels compatible with downstream membrane separation units and may be selected for its operational simplicity and robustness.

Alternatively, the softening process circuit (108) can include membrane separation, including NF, RO, and related configurations, which may be implemented in single- or multi‑stage arrangements to achieve a desired balance between impurity rejection, recovery, flux stability, and fouling control. Staged membrane configurations allow operating conditions such as pressure, recovery, and cross‑flow velocity to be distributed across stages, thereby enhancing separation efficiency and maintaining stable performance when treating lithium‑bearing eluates containing boron and other dissolved species.

In some embodiments, nanofiltration is implemented in the softening process circuit (108) in multiple stages to progressively reduce divalent and multivalent ion concentrations upstream of reverse osmosis units, while reverse osmosis units are arranged in series, cascaded, or recirculating configurations to achieve targeted boron partitioning, rejection, and water recovery. The selection between single‑stage and multi‑stage operation for a given unit process may be based on feed composition, impurity loading, desired recovery, and integration with the overall direct lithium extraction flowsheet.

A filtration process circuit (112) can be employed downstream of the softening process circuit (108) to remove the precipitates from a softened eluate (110), thereby mitigating scaling risks and enhancing RO membrane performance. The filtration process circuit (112) can employ single‑ or multi‑stage media filtration, microfiltration, ultrafiltration, or other suitable filtration. In certain embodiments, the filtration process circuit (112) is implemented as a single‑stage solid–liquid separation step sufficient to remove precipitated hardness salts prior to downstream membrane separation. In other embodiments, the filtration process circuit (112) comprises multiple filtration stages or finer‑pore filtration, such as microfiltration or ultrafiltration, selected to further reduce particulate loading and protect downstream nanofiltration and/or reverse osmosis membranes.

A filtered eluate (114) from the filtration process circuit (112) can be passed to a polishing process circuit (116) to polish the softened, filtered eluate (114) if needed, removing trace levels of calcium or magnesium that remain after softening. The polishing process circuit (116) ensures compatibility with downstream high-performance RO membranes. The polishing process circuit (116) can employ suitable membrane separation, such as nanofiltration and/or ion exchange, to remove hardness ions, such as calcium and magnesium, before the downstream membrane separation process circuit (120). In certain embodiments, the polishing process circuit (116) is implemented as a single‑stage operation configured to remove residual hardness ions remaining after bulk softening and filtration. In such embodiments, nanofiltration and/or ion exchange is employed as a polishing step rather than as a primary separation stage, thereby providing fine control of calcium and magnesium concentrations prior to the downstream reverse osmosis process circuit.

A polished lithium-containing eluate (118) is directed to the multi-stage membrane separation process circuit (120). The first-stage RO unit (122) operates under low-pH/acidic conditions (pH of up to about 8 or more preferably about 6 to about 7) (and any value or range therebetween), such that boron predominantly migrates from the polished eluate (118) into the boron-laden permeate stream (126) (approximately 80 % to approximately 90 % recovery), taking advantage of hydraulic partitioning. The pH of the feed eluate (118) can be adjusted using a suitable acid, such as a chlorine-based acid (e.g., hydrochloric acid) or a sulfur-based acid (e.g., sulfuric acid). The first-stage RO unit (122) can utilize any suitable industrial RO membrane for low pH environments, such as but not limited to, conventional reverse osmosis, TFC reverse osmosis, cellulose acetate reverse osmosis, BWRO, SWRO, high-pressure reverse osmosis, ULP, acid-resistant reverse osmosis, alkaline-resistant reverse osmosis, high-pH reverse osmosis, CFRO, OARO, forward-osmosis-assisted reverse osmosis, and/or hybrid FO-RO configurations, in closed-circuit, cyclic, batch, or semi-batch reverse osmosis configurations.

The purified lithium-containing eluate with substantially reduced boron content (124) flows downstream to a conversion process circuit (1000) for the production of high-purity lithium hydroxide and/or lithium carbonate. For example, the purified lithium-containing eluate (124) can be converted to lithium hydroxide using an electrolysis process or a chemical precipitation process (e.g., precipitation with calcium hydroxide (Ca(OH)₂)) or can be converted to lithium carbonate using a carbonation process (e.g., reacting with carbon dioxide (CO₂)) or a chemical precipitation process (e.g., precipitation with sodium carbonate (Na₂CO₃)). The purified lithium-containing eluate (124) can be sequentially converted to lithium hydroxide and lithium carbonate, such as but not limited to, by first converting the lithium-containing eluate (124) to lithium hydroxide using the electrochemical or chemical precipitation process and then carbonating the lithium hydroxide with carbon dioxide to produce lithium carbonate. The purified lithium-containing eluate (124) can also be directly converted to high-purity lithium hydroxide or carbonate using a direct conversion process, such as solvent extraction or direct lithium conversion (DLC). Various fluid streams from the conversion process circuit (1000), e.g., the mother liquor or process condensate, can be recycled to the pretreatment circuit, the DLE process circuit (102), the impurity removal process circuit (106), the reverse osmosis process circuit (120), or a combination thereof.

The boron-laden permeate stream (126) proceeds from the first-stage RO unit (122) to the second-stage RO unit (128) to remove up to about 99 % of the residual boron. The second-stage RO unit (128) operates under high-pH/alkaline conditions (pH of between about 10 to about 14 or more preferably about 11 and about 12) (and any value or range therebetween) to convert boric acid (H₃BO₃) in the boron-laden permeate stream (126) to borate (BO₃ ³⁻). The pH of the boron-laden permeate stream (126) can be adjusted using a suitable alkali, such as sodium hydroxide (NaOH), potassium hydroxide (KOH), or lithium hydroxide (LiOH). The second-stage RO unit can utilize any suitable industrial RO membrane to convert boric acid into borate in high-pH environments, including but not limited to conventional reverse osmosis, TFC reverse osmosis, cellulose acetate reverse osmosis, BWRO, SWRO, high-pressure reverse osmosis, ULP, acid-resistant reverse osmosis, alkaline-resistant reverse osmosis, high-pH reverse osmosis, CFRO, OARO, forward-osmosis-assisted reverse osmosis, and/or hybrid FO-RO configurations, in closed-circuit, cyclic, batch, or semi-batch reverse osmosis configurations.

The boron-reduced permeate stream (130) from the second-stage RO unit (128) is recycled to the DLE process circuit (102) for water recovery, thereby significantly reducing the need for additional freshwater inputs. A boron-laden concentrate stream (132) that is enriched in boron relative to the feed to the second membrane separation stage (128) is handled separately or, if required, subjected to additional treatment. Rather than being discarded or further diluted, the boron‑laden concentrate stream (132) may be collected as a product stream (134). Collecting the boron‑laden concentrate stream (132) as a discrete stream may improve overall water balance, reduce waste-handling requirements, and enable recovery of boron values that would otherwise be lost from the process.

In some embodiments, the boron‑laden concentrate stream (132) is withdrawn from the second membrane separation stage (128) at a controlled flow rate and concentration selected to maintain stable membrane operation while producing the boron‑laden concentrate stream (132) suitable for downstream handling. The boron‑laden concentrate stream (132) may comprise water and dissolved boron species, including borate species formed under alkaline conditions, and may optionally contain minor amounts of other dissolved salts depending on upstream process conditions and membrane selectivity. The boron‑laden concentrate stream (132) may be collected continuously or intermittently and may be stored, transported, or directed to further processing as desired.

In further embodiments, the collected boron‑laden concentrate stream (132) is further processed (136) to produce the borate‑containing product stream (134), including one or more borate salts. Such further processing may include, for example, concentration, neutralization, crystallization, precipitation, evaporation, or combinations thereof, selected to recover boron in a solid or otherwise isolable form. The specific borate salt produced may depend on the chemistry of the boron‑laden concentrate stream (132), the alkali used to adjust pH in the second membrane separation stage (128), and any additional reagents introduced during downstream processing.

In some embodiments, the boron‑laden concentrate stream (132) produced under alkaline conditions is processed to recover a sodium borate, potassium borate, lithium borate, or mixed borate salt as the product stream (134), without requiring the introduction of additional boron‑containing reagents. In other embodiments, the boron‑laden concentrate stream (132) may be conditioned, blended, or reacted with one or more reagents to produce a borate salt having desired purity or physical characteristics. Processing of the boron‑laden concentrate stream (132) to produce a borate salt may provide a valuable by‑product, improve overall process economics, and further reduce the environmental footprint of the DLE process circuit (102).

In certain embodiments, the multi‑stage membrane process (120) is operated within defined operating envelopes selected to promote preferential boron partitioning in the first membrane separation stage (122) and enhanced boron rejection in the second membrane separation stage (128). In some embodiments, the control system monitors one or more of conductivity, pressure, flow rate, temperature, and differential pressure associated with each membrane separation stage (122, 128). These parameters may be used to detect changes in membrane performance, fouling, scaling, or boron transport behavior. For example, a change in permeate conductivity, flux, or recovery under otherwise similar operating conditions may indicate a change in boron passage behavior and prompt adjustments to operating pressure, recovery, cross-flow velocity, or pH setpoints. In some embodiments, operating parameters are adjusted in response to monitored conditions to maintain preferential boron passage in the first membrane separation stage (122) and boron rejection in the second membrane separation stage (128) within predetermined performance targets.

In some embodiments, the control system is configured to implement adaptive control strategies, including staged adjustment of recovery, cross-flow velocity, operating pressure, or reagent dosing, in response to changes in boron concentration in one or more feed, permeate, or concentrate streams. Such adaptive control may be beneficial when processing eluates derived from the DLE process circuit (102) operating on variable brine sources. In one illustrative control scenario, an increase in boron concentration in the permeate stream (126) from the first membrane separation stage (122) may trigger adjustment of pH, recovery, operating pressure, or cross-flow velocity to maintain preferential boron partitioning in the first membrane separation stage (122), while an increase in boron passage through the second membrane separation stage (128) may trigger adjustment of alkaline dosing, operating pressure, cross-flow velocity, or recovery to enhance boron rejection in the second membrane separation stage (128).

In one embodiment, the first membrane separation stage (122) is operated under acidic or near‑neutral conditions, with the boron-laden permeate stream (126) adjusted to a pH of up to about 8, and more preferably between about 6 and about 7, so that boron present in the boron-laden permeate stream (126) is predominantly in the form of boric acid (H₃BO₃). Under these conditions, boron exhibits increased passage through the membrane separation relative to lithium, thereby promoting hydraulic partitioning of boron into the boron-laden permeate stream (126) while retaining the purified lithium-containing eluate stream (124) having reduced boron content.

In non‑limiting examples, the first membrane separation stage (122) may be operated at transmembrane pressures of about 10 to about 80 bar, at temperatures from ambient to about 60 °C, and at recoveries selected to maintain stable boron partitioning without excessive concentration polarization. The first membrane separation stage (122) may be operated over a range of transmembrane pressures suitable for the selected reverse osmosis configuration, including conventional, osmotically assisted, counterflow, or multi‑stage arrangements. Operating pressure, recovery, and cross‑flow velocity may be selected to balance boron passage, lithium retention, and membrane fouling resistance. In some embodiments, the first stage (122) is operated at moderate recoveries to maintain stable boron partitioning and reduce concentration polarization.

In the second membrane separation stage, the boron‑laden concentrate stream (126) is adjusted to alkaline conditions, with the pH raised to about 10-14, more preferably about 11-12, so that boric acid is converted to borate species. Under these alkaline conditions, boron exhibits greater membrane rejection than water, enabling the production of the boron-reduced permeate stream (130) with reduced boron content relative to the feed (boron-laden permeate stream (126)) to the second stage (128).

In non‑limiting examples, the second membrane separation stage (128) may be operated at pressures and recoveries selected to enhance boron rejection while maintaining membrane integrity under alkaline conditions. In some embodiments, the second stage (128) is operated at lower recoveries than the first stage (122) to minimize boron passage and scaling risk under high‑pH conditions. The resulting permeate stream (130) may be suitable for recycling upstream to the DLE process circuit (102).

The operating envelopes of the first (122) and second (128) membrane separation stages may be independently selected and adjusted, allowing decoupling of boron partitioning performance from boron rejection performance. This staged approach enables robust boron management across a wide range of lithium‑bearing eluate compositions.

The invention can incorporate advanced process sensors and controls to maintain system stability, enhance efficiency, and reduce energy consumption. These sensors and controls include automated systems for managing flow rates to adjust feed and recycle flow rates, optimizing recovery rates, and ensuring consistent eluate treatment. The inventive process and circuit can also utilize real-time sensors and controllers to monitor the pH of the eluate before each RO stage. Dosing systems precisely adjust the pH using acids (e.g., HCl) or alkaline agents (e.g., NaOH), maintaining target pH ranges for boron partitioning. In addition, sensors can detect fouling or scaling on RO membranes, triggering automated cleaning cycles to maintain optimal performance. Variable frequency drives (VFDs) can regulate pump speeds to minimize energy consumption during RO operations. The invention can utilize other integrated sensors to monitor other key parameters, such as solution concentration, pressure drops, and column performance.

In certain embodiments, the multi‑stage boron removal process circuit (120) is operated under active process control to maintain boron removal performance within a desired operating window despite variations in feed composition, temperature, flow rate, or membrane condition.

In one embodiment, pH control is implemented upstream of each membrane separation stage (122, 128) using one or more pH sensors positioned to monitor the eluate and the boron‑enriched permeate stream, respectively. Signals from the pH sensors may be provided to a control system configured to adjust acid or alkali dosing to maintain the first and second pH conditions within predetermined target ranges. Maintaining stable pH conditions may reduce variability in boron speciation and improve consistency of boron partitioning and rejection. Control actions may be implemented by automated control systems, operator‑directed adjustments, or combinations thereof.

In certain embodiments, the control system further monitors one or more of conductivity, pressure, flow rate, temperature, and differential pressure across each membrane separation stage (122, 128). These parameters may be used to infer changes in membrane performance, fouling, scaling, or boron passage behavior. For example, changes in permeate conductivity or recovery at constant operating conditions may indicate a shift in boron transport behavior, prompting adjustment of operating pressure, recovery, or pH setpoints. In some embodiments, operating parameters are adjusted in response to monitored conditions to maintain boron passage in the first membrane separation stage (122) and boron rejection in the second membrane separation stage (128) within predetermined performance targets.

In some embodiments, the control system is configured to implement adaptive control strategies, including staged adjustments to recovery or cross‑flow velocity, in response to changes in boron concentration in the feed or permeate streams. Such adaptive control may be particularly beneficial when processing eluates derived from the DLE process circuit (102) operating on variable brine sources. In an illustrative control scenario, an increase in boron concentration in the permeate (126) of the first membrane separation stage (122) may trigger adjustment of pH, recovery, or cross‑flow velocity to maintain preferential boron partitioning, while an increase in boron passage through the second membrane separation stage (128) may trigger adjustment of alkaline dosing or reduction in recovery to enhance boron rejection.

In further embodiments, the inventive circuit and process may include hardness‑management control, wherein upstream softening, filtration, nanofiltration, or ion exchange units are operated under feedback control to limit calcium and magnesium concentrations entering the membrane separation stages. By maintaining hardness ions below scaling thresholds, membrane performance and boron removal stability may be improved over extended operating periods.

In some embodiments, the control system is configured to manage permeate recycle ratios, such that at least a portion of the boron‑reduced permeate (130) from the second membrane separation stage (128) is recycled to the DLE process circuit (102) at a controlled rate. Recycling may be dynamically adjusted based on water balance, lithium recovery targets, or boron accumulation trends across the overall process circuit.

In certain embodiments, the process further includes clean‑in‑place (CIP) control logic, wherein membrane cleaning cycles are initiated based on monitored pressure drop, flux decline, or boron removal performance degradation. Cleaning chemistry and frequency may be selected to maintain membrane selectivity under both acidic and alkaline operating conditions.

In a pilot-scale demonstration, an alumina adsorbent-based DLE system produced an eluate containing 200 ppm of boron. The first RO stage, operating at pH 6, partitioned 85 % of the boron into the permeate. The concentrate was then adjusted to a pH of 11.5 and processed through the second RO stage, achieving an additional 99 % rejection of boron. The resulting permeate was boron-reduced and reintegrated into the DLE process circuit.

For the purposes of this disclosure, the term “at least” followed by a number is used herein to denote the start of a range beginning with that number (which may be a range with an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40 %” means 40 %or less than 40 %.

Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ± 10 % of the base value.

As used herein, the term “fluidly connected” means connected by a fluid transfer conduit or any other method that permits fluid transfer, with or without intervening elements, such as, without limitation, containers, filters, devices, pumps, valves, etc. As a non-limiting example, two tanks or vessels may be “fluidly connected” if they are connected by a pipe or tube, even if a pump, manifold, valve, or other device is placed inline between the vessels. Two elements are considered to be “fluidly connected” even though there is no pipe or tubing making the connection if the first element leaks or otherwise drains, overflows, siphons, or transfers into the second element, though there may be no actual physical connection between the two elements in the form of a pipe or tube.

As used herein, the term “in fluid communication with” means that a fluid-carrying or fluid-transporting member (e.g., vessel, tank, pump, pipe, tubing, disc, valve, channel, port, etc.) is coupled to another fluid-carrying or fluid-transporting member to permit the fluid to flow, leak, or otherwise migrate from one member to the other. In reference to a process or circuit, the term “downstream” means later in the direction of general process and/or fluid flow, and “upstream” means earlier in the direction of general process and/or flow.

Although an overview of the disclosed subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A process for removing boron from a lithium-containing eluate in a direct lithium extraction process, comprising:
receiving a lithium-containing eluate containing boron impurities from a direct lithium extraction process;
adjusting a pH of the lithium-containing eluate to a first pH condition to facilitate partitioning of boron;
passing the lithium-containing eluate through a first-stage membrane separation unit to produce a boron-laden permeate stream and a lithium-containing eluate with reduced boron content;
adjusting the pH of the boron-laden permeate stream to a second pH condition to convert boric acid into borate ions;
passing the boron-laden permeate stream through a second-stage membrane separation unit to further reduce boron content and produce a boron-reduced permeate stream; and
recycling the boron-reduced permeate stream.

2. The process of claim 1, wherein the adjusting the pH of the lithium-containing eluate comprises adjusting the pH of the lithium-containing eluate to the first pH condition of up to about 8, preferably about 6 to about 7, to facilitate hydraulic partitioning of boron into the boron-laden permeate stream.

3. The process of claim 2, wherein the adjusting the pH of the lithium-containing eluate comprises adjusting the pH of the lithium-containing eluate to the first pH condition using an acid comprising hydrochloric acid or sulfuric acid.

4. The process of claim 1, wherein the first-stage boron membrane separation unit comprises an acid-resistant membrane comprises conventional membranes, thin-film composite membranes, cellulose acetate membranes, seawater reverse osmosis membranes, high-pressure reverse osmosis membranes, osmotically assisted reverse osmosis membranes, counterflow reverse osmosis membranes, forward osmosis with reverse osmosis hybrid membranes, or a combination thereof.

5. The process of claim 4, further comprising operating the first-stage membrane separation unit in a continuous, batch, semi-batch, cyclic, staged, cascaded, recirculating, counter-current, co-current, or hybrid configuration.

6. The process of claim 4, wherein the acid-resistant membrane comprises one or more membrane elements arranged in series or parallel.

7. The process of claim 1, wherein the adjusting the pH of the boron-laden permeate stream comprises adjusting the pH of the boron-laden permeate stream to a value between about 10 and about 14 to convert boric acid into borate ions.

8. The process of claim 7, wherein the adjusting the pH of the boron-laden permeate stream to the second pH condition comprises an addition of an alkali comprising sodium hydroxide, potassium hydroxide, lithium hydroxide, or a combination or mixture thereof.

9. The process of claim 1, wherein the second-stage membrane separation unit comprises an alkaline-resistant membrane comprising conventional membranes, alkaline-resistant thin-film composite membranes, brackish water reverse osmosis membranes, ultra-low pressure reverse osmosis membranes, specialized high-pH reverse osmosis membranes, or a combination thereof.

10. The process of claim 9, further comprising operating the second-stage membrane separation unit in a continuous, batch, semi-batch, cyclic, staged, cascaded, recirculating, counter-current, co-current, or hybrid configuration.

11. The process of claim 9, wherein the alkaline-resistant membrane comprises one or more membrane elements arranged in series or parallel.

12. The process of claim 1, further comprising, prior to the direct lithium extraction process, directing a lithium-containing feed solution containing boron impurities to a pretreatment process circuit configured to remove one or more impurities.

13. The process of claim 1, wherein the direct lithium extraction process is configured to operate in a fixed bed, simulated moving bed, continuous counter-current ion exchange (CCIX), or continuous counter-continuous counter-current adsorption/desorption (CCAD) configuration.

14. The process of claim 1, further comprising directing the lithium-containing eluate containing boron impurities to an impurity removal process circuit configured for removing hardness ions comprising calcium and magnesium ions to produce the lithium-containing eluate with reduced boron content.

15. The process of claim 14, wherein the impurity removal process circuit comprises softening the lithium-containing eluate containing boron impurities, filtering the lithium-containing eluate containing boron impurities, and/or polishing the lithium-containing eluate containing boron impurities.

16. The process of claim 1, further comprising directing the lithium-containing eluate with reduced boron content to a conversion process circuit to produce one or more borate salt products.

17. The process of claim 1, further comprising monitoring the pH of the lithium-containing eluate and/or the boron-laden permeate stream using sensors and adjusting an addition of the acid or alkali based on a monitored pH values.

18. A direct lithium extraction system, comprising:
a direct lithium extraction process circuit configured to produce a lithium-containing eluate from a lithium-containing feed solution; and
a multi-stage membrane separation circuit configured for boron removal from the lithium-containing eluate to produce a boron-reduced permeate stream and a boron-laden concentrate stream.

19. The system of claim 18, wherein the multi-stage membrane separation process circuit further comprises:
a first-stage boron reverse osmosis unit configured to partition boron into a boron-laden permeate stream and produce a lithium-containing eluate with reduced boron content;
a second-stage boron reverse osmosis unit configured to further reduce boron content and produce a boron-reduced permeate stream; and
a recycle conduit fluidly connecting the boron-reduced permeate stream from the second-stage reverse osmosis unit to the direct lithium extraction process circuit.

20. The system of claim 19, wherein:
the first-stage boron reverse osmosis unit includes an acid-resistant membrane comprising a conventional reverse osmosis membrane, a thin-film composite reverse osmosis membrane, a cellulose acetate reverse osmosis membrane, a seawater reverse osmosis membrane, a high-pressure reverse osmosis membrane, a osmotically assisted reverse osmosis membrane, a counterflow reverse osmosis membrane, a forward osmosis with reverse osmosis hybrid membrane, or a combination thereof,
the acid-resistant membrane comprises one or more membrane elements arranged in series or parallel; and/or
the first-stage reverse osmosis unit comprises a continuous, batch, semi-batch, cyclic, staged, cascaded, recirculating, counter-current, co-current, or hybrid configuration.

21. The system of claim 19, wherein:
the second-stage boron reverse osmosis unit includes an alkaline-resistant membrane comprising a conventional membrane, an alkaline-resistant thin-film composite membrane, a brackish water reverse osmosis membrane, an ultra-low pressure reverse osmosis membrane, a specialized high-pH reverse osmosis membrane, or a combination thereof,
the alkaline-resistant membrane comprises one or more membrane elements arranged in series or parallel, and/or
the second-stage boron reverse osmosis unit is operated in continuous, batch, semi-batch, cyclic, staged, cascaded, recirculating, counter-current, co-current, or hybrid configurations.

22. The system of claim 18, further comprising a pretreatment process circuit upstream of the direct lithium extraction process circuit and configured to remove one or more impurities from the lithium-containing feed solution.

23. The system of claim 18, wherein the direct lithium extraction process circuit is a fixed bed, simulated moving bed, continuous counter-current ion exchange (CCIX), or continuous counter-continuous counter-current adsorption/desorption (CCAD) process circuit.

24. The system of claim 18, further comprising an impurity removal process circuit downstream of the direct lithium extraction process circuit and configured for removing hardness ions comprising calcium and magnesium ions to produce the lithium-containing eluate with reduced boron content.

25. The system of claim 24, wherein the impurity removal process circuit comprises a softening process circuit, a filtration process circuit, and/or a polishing process circuit.

26. The system of claim 25, further comprising a conversion process circuit downstream of the impurity removal process circuit and configured to produce one or more borate salt products.
